(19) United States
(12) Patent Application Publication
(10) Pub. No.: US 2008/0013542 A1
(43) Pub. Date: Jan. 17, 2008

(54) APPARATUS AND METHOD FOR TRANSMITTING MEDIA DATA AND APPARATUS AND METHOD FOR RECEIVING MEDIA DATA

(75) Inventors: Sun-hee YOUM, Seoul (KR); Kyung-sun CHO, Seoul (KR); Jeong-hoon PARK, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/776,782

(22) Filed: Jul. 12, 2007

Related U.S. Application Data
(60) Provisional application No. 60/830,101, filed on Jul. 12, 2006.

(30) Foreign Application Priority Data
Mar. 8, 2007 (KR) 10-2007-0023193

(51) Int. Cl. H04L 12/56

(52) U.S. Cl. 370/395.3

(57) ABSTRACT

An apparatus for and method of transmitting media data, and an apparatus for and method of receiving media data are provided. The method of transmitting media data includes determining whether to multiplex a media data item; determining a stream identifier for identifying a packetization layer packet of a media data item; packetizing the media data item to generate a packetization layer packet; and transmitting the packetization layer packet, wherein the packetization layer packet has a recursive structure in which an aggregated unit having a same packet structure as the packetization layer packet is included in a payload field of the packetization layer packet. The method for receiving media data includes processing received transport layer data; inverse packetizing a packetization layer packet and identifying a payload data type of the packet; and if the payload data type indicates an aggregated unit, inverse packetizing the aggregated unit.

### CROSS-REFERENCE TO RELATED PATENT APPLICATIONS

This application claims priority from Korean Patent Application No. 10-2007-0023193, filed on Mar. 8, 2007, in the Korean Intellectual Property Office, and the benefit of U.S. Provisional Patent Application No. 60/830,101, filed on Jul. 12, 2006, in the U.S. Patent and Trademark Office, the disclosures of which are incorporated herein in their entirety by reference.

### BACKGROUND OF THE INVENTION

1. Field of the Invention

Methods and apparatuses consistent with the present invention relate to transmitting and receiving media data, and more particularly, to transmitting media data by which media data is effectively multiplexed and transmitted by using a simple multiplexing method, and receiving and processing the transmitted media data.

2. Description of the Related Art

FIG. 1 is a diagram illustrating a hierarchical structure in a media system, and the relationship between layers according to related art technology.

A related art media system can be simplified into a stream layer, a packetization layer and a transport layer as illustrated in FIG. 1. The stream layer is an encoded stream of media data, such as audio, video, and text. The stream in the stream layer may be an H.264 video stream or an advanced audio coding (AAC) audio stream. Since the stream in the stream layer does not have a start indicator of an access unit, if the stream is output from an encoder, it is formed as a packet that can be processed with reference to information, such as time information and length information, in the packetization layer. The packetization layer indicates a Moving Picture Experts Group (MPEG)-4 packetized elementary stream (PES), an MPEG-4 synchronized layer (SL), or an MPEG-4 simple aggregation format (SAF). The transport layer processes the packet into a structure appropriate for transmission, and transmits the packet. The transport layer indicates an MPEG-2 transport stream (TS), or real-time transport protocol (RTP).

However, generation of each packetization layer for each stream and then, transmission of the packetization layer through a transmission channel of a separate transmission layer, as illustrated in FIG. 1, may be inefficient. In particular, when rich media content formed with a variety of types of media data is transmitted, transmitting the media data by assigning each transmission channel to each media data type is inefficient.

In order to effectively transmit a packetized media stream, an MPEG-4 system uses a flux multiplexer (FluxMux) to reduce overhead of a transmission multiplexing unit (TransMux) or to compensate for a shortage of logical channels of the transmission multiplexing unit (TransMux). If multiplexing is performed using a multiplexer such as the FluxMux, a transmitting side of a media stream requires a process of generating multiplexing information and generating multiplexed packets according to a flux multiplexing method in addition to a packetizer of a packetization layer. Also, a reception side of the media stream requires a separate demultiplexer for processing multiplexed packets using multiplexing information.

### SUMMARY OF THE INVENTION

The present invention provides an apparatus for and method of transmitting media data by which a packet of a packetization layer is efficiently multiplexed and transmitted without a separate multiplexing operation or the need for a separate multiplexer.

The present invention also provides an apparatus for and method of receiving media data by which a generated packet of a packetization layer is processed and media data is effectively received and processed.

According to an aspect of the present invention, there is provided method of transmitting media data including determining whether to multiplex an input media data item, based on a characteristic of the input media data item; determining at least one stream identifier for identifying a packetization layer packet of the input media data item for which multiplexing is determined to be performed; packetizing the input media data item, thereby generating the packetization layer packet which is distinguished by the stream identifier; and transmitting the packet, wherein the packet has a recursive structure in which an aggregated unit having the same packet structure as the packet is included in a payload field.

The characteristic of the input media data item may be at least one of whether or not media data globally exists in a content service including at least one media data item, whether or not media data is continuous, and whether or not a media data item is related to at least one or more other media data items.

At least one other packet identified by a same stream identifier as the packetization layer packet may exist, and the at least one other packet having the same stream identifier may transmit media data or decoder information in the payload field according to a payload data type.

The packet having the recursive structure may be generated by packetizing the media data item for which multiplexing is determined to be performed, as a packet identified by a first stream identifier, and packetizing the packet identified by the first stream identifier, as a packet identified by a second stream identifier.

The generating of the packetization layer packet may be performed at least once.

According to another aspect of the present invention, there is provided an apparatus for transmitting media data including a media characteristic analysis unit which determines whether to multiplex an input media data item, based on a characteristic of the input media data item, and determines at least one stream identifier for identifying the packetization layer packet of the input media data item for which multiplexing is determined to be performed; a packetization layer packetizing unit which packetizes the input media data item, thereby generating the packetization layer packet which is distinguished by the stream identifier; and a transport layer processing unit which transmits the packet, wherein the packet has a recursive structure in which an aggregated unit having a same packet structure as the packet is included in a payload field.

According to another aspect of the present invention, there is provided a method of receiving media data including processing received transport layer data, thereby generating a packetization layer packet; inverse packetizing the packetization layer packet, and confirming a payload data type of the packet; and if the payload data type indicates that an aggregated unit having a same packet structure as that of the packet is included in the payload field of the packet, inverse packetizing the aggregated unit in a same manner as the inverse packetizing of the packetization layer packet.

The method may further include, if the payload data type indicates that a media data item is included in the payload field of the packet, decoding the media data item.

When at least one or more packets having identical stream identifiers are received and at least one packet is selected from among the packets having identical stream identifiers, remaining packets having the identical stream identifiers may be selected together.

Identical processing may be performed for the selected packets having the identical stream identifiers.

According to another aspect of the present invention, there is provided an apparatus for receiving media data including a transport layer processing unit which processes received transport layer data, thereby generating a packetization layer packet; and a packetization layer inverse packetizing unit which inverse packetizes the received packetization layer packet, and confirms a payload data type of the packet, wherein if the payload data type indicates that an aggregated unit having a same packet structure as that of the packet is included in the payload field of the packet, the packetization layer inverse packetizing unit inverse packetizes the aggregated unit in a same manner as the inverse packetizing of the packetization layer packet.

According to another aspect of the present invention, there is provided a computer readable recording medium having embodied thereon a computer program for executing a method of transmitting media data, wherein the method includes determining whether to multiplex an input media data item, based on a characteristic of the input media data item; determining at least one stream identifier for identifying a packetization layer packet of the input media data item for which multiplexing is determined to be performed; packetizing the input media data item, thereby generating the packetization layer packet which is distinguished by the stream identifier; and transmitting the packet, wherein the packet has a recursive structure in which an aggregated unit having a same packet structure as the packet is included in a payload field.

According to another aspect of the present invention, there is provided a computer readable recording medium having embodied thereon a computer program for executing a method of receiving media data, wherein the method includes processing received transport layer data, thereby generating a packetization layer packet; inverse packetizing the packetization layer packet, and confirming a payload data type of the packet; and if the payload data type indicates that an aggregated unit having a same packet structure as that of the packet is included in the payload field of the packet, inverse packetizing the aggregated unit in a same manner as the inverse packetizing of the packetization layer packet.

### BRIEF DESCRIPTION OF THE DRAWINGS

The above and other aspects of the present invention will become more apparent by describing in detail exemplary embodiments thereof with reference to the attached drawings in which:

FIG. 1 is a diagram illustrating a hierarchical structure in a media system, and the relationship between layers according to related art technology;

FIG. 2 is a diagram illustrating a structure of a packet of a packetization layer according to an exemplary embodiment of the present invention;

FIG. 3 is a diagram illustrating a structure of a packet of a packetization layer according to a payload data type according to an exemplary embodiment of the present invention;

FIG. 4 is a diagram illustrating a structure of an aggregated unit according to an exemplary embodiment of the present invention;

FIG. 5 is a block diagram illustrating a structure of a media data transmission apparatus according to an exemplary embodiment of the present invention;

FIG. 6 is a flowchart illustrating a method of transmitting media data according to an exemplary embodiment of the present invention;

FIGS. 7A and 7B are a more detailed flowchart illustrating the method of transmitting media data illustrated in FIG. 6 according to an exemplary embodiment of the present invention;

FIG. 8 is a block diagram illustrating a structure of an apparatus for receiving media data according to an exemplary embodiment of the present invention;

FIG. 9 is a flowchart illustrating a method of receiving media data according to an exemplary embodiment of the present invention;

FIG. 10 is a diagram illustrating a structure of layers when a transport layer according to an exemplary embodiment of the present invention is an MPEG-2 TS;

FIG. 11 is a diagram illustrating a structure of a program map table (PMT) of the MPEG-2 TS in the case illustrated in FIG. 10 according to an exemplary embodiment of the present invention;

FIG. 12 is a diagram illustrating a structure of layers when a transport layer according to an exemplary embodiment of the present invention is a real-time transport protocol (RTP); and

FIG. 13 is a diagram illustrating a structure of a session description protocol (SDP) of the RTP in the case illustrated in FIG. 12 according to an exemplary embodiment of the present invention.

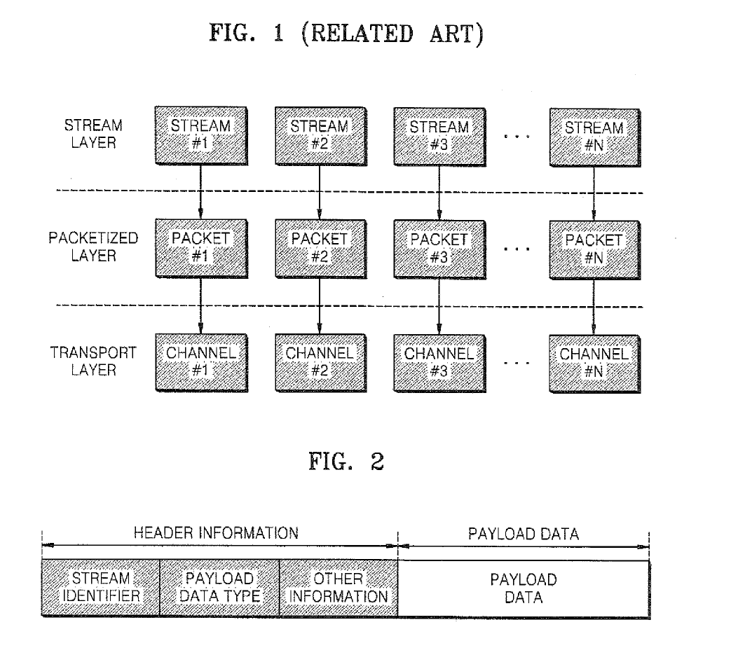

### DETAILED DESCRIPTION OF THE INVENTION

The present invention will now be described more fully with reference to the accompanying drawings, in which exemplary embodiments of the invention are shown.

FIG. 2 is a diagram illustrating a structure of a packet of a packetization layer according to an exemplary embodiment of the present invention.

In the present invention, a packet of a packetization layer has an packet structure in which an identifier and a transmission data type (payload data type) are included in a header. The packet structure may be arbitrary. According to an exemplary embodiment of the present invention, a packet of a packetization layer is composed of a header field including a stream identifier, a payload data type, and other information (other field), and a payload field including payload data. In the present specification, an identifier for identifying a packet of a packetization layer is referred to as a stream identifier. The payload data type indicates the type of payload data included in the payload field. Other information includes a field indicating structure information of a packet, or additional information on data transferred using the payload unit, for example, a timestamp, length information, and the like.

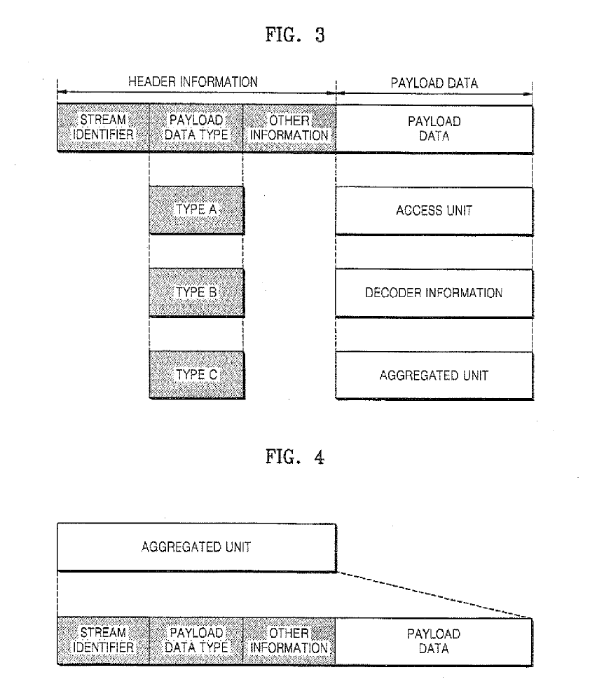

FIG. 3 is a diagram illustrating a structure of a packet of a packetization layer according to a payload data type according to an exemplary embodiment of the present invention.

As illustrated in FIG. 3, the packet of the packetization layer according to the current exemplary embodiment can include an access unit of media data, decoder information of media data, or an aggregated unit in the payload unit according to the payload data type.

For example, as illustrated in FIG. 3, if the payload data type is A, it indicates that the payload field includes an access unit of media data, if the payload data type is B, it indicates that the payload field includes decoder information, and if the payload data type is C, it indicates that the payload field includes an aggregated unit. The payload data type can be expressed in a variety of formats, and may include other information used for transmitting media data in the payload unit. Even if packets have same identifiers, the payload unit may include an access unit, decoder information, or an aggregated unit depending on the payload data type as illustrated in FIG. 3. That is, even among packets identified by same stream identifiers, one packet may be, for example, a packet for transmitting encoded media data in the payload field, and another packet may be a packet for transmitting an aggregated unit in the payload field. In the packet for transmitting the aggregated unit in the payload field, the stream identifier can be regarded as a stream identifier for multiplexing. The aggregated unit will be explained with reference to FIG. 4.

FIG. 4 is a diagram illustrating a structure of an aggregated unit according to an exemplary embodiment of the present invention.

The aggregated unit illustrates a case where a packet of a packetization layer different from a current packetization layer but having a same structure as the packet of the current packetization layer is included in a payload field. According to the current exemplary embodiment, in order to multiplex a first packet obtained by packetizing media data, a separate multiplexing method and apparatus, such as an MPEG-4 FluxMux are not used. Instead, a second packet of a packetization layer, including the first packet in the payload field of the packetization layer, is generated, and thus a different method of multiplexing can be performed.

If the packetization layer is multiplexed according to the current exemplary embodiment, a recursive multiplexing structure can be implemented. Also, when a packetization layer packet is multiplexed, if the packet is input again into a packetization layer packetizer, a multiplexing packet in which the packetization layer packet is included in the payload field is generated, and thus multiplexing which does not need separate multiplexing configuration information (multiplexing without multiplexing configuration) can be implemented. Accordingly, simplification of a method of multiplexing media data can be achieved.

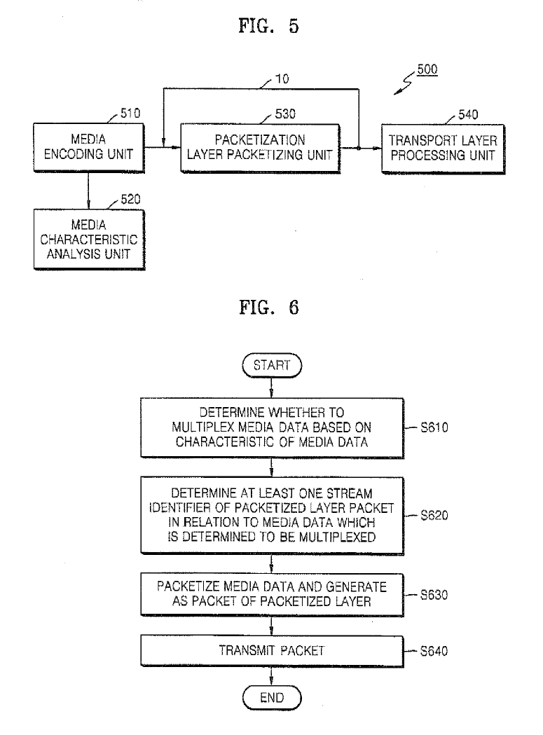

FIG. 5 is a block diagram illustrating a structure of a media data transmission apparatus according to an exemplary embodiment of the present invention. The media data transmission apparatus 500 includes a media encoding unit 510, a media characteristic analysis unit 520, a packetization layer packetizing unit 530, and a transport layer processing unit 540.

The media data transmission apparatus 500 transmits media data in order to provide a content service. The content service provides contents through a variety of transmission channels. Here, the content service denotes providing content formed with media data, such as a movie, a song, a TV episode, or the like.

The media encoding unit 510 transfers characteristic information on at least one or more media data items used for providing a content service, to the media characteristic analysis unit 520, and encodes the media data into a media stream. The media encoding unit 510 is formed with one or more encoders capable of encoding each media data item according to a type of the media data item.

The media characteristic analysis unit 520 determines whether to multiplex an input media data item, based on a characteristic of the input media data item. Also, the media characteristic analysis unit 520 determines how to multiplex a plurality of media data items in a packetization layer and a number of times multiplexing is to be performed, thereby determining a multiplexing structure of each media data item transferred through the content service. In particular, the media characteristic analysis unit 520 determines a stream identifier for identifying the packetization layer packet of a media data item which is determined to be multiplexed. Based on the determined multiplexing structure, it can be determined that one or more stream identifiers are assigned to one media data item.

The characteristic of a media data item may be at least one of whether media data globally exists in a content service including at least one media data item, whether media data is continuous, and whether a media data item is related to one or more other media data items.

The following cases are indicated by whether media data globally exists in a content service including at least one media data item. In a case where a television broadcasting program is provided as a content service, video data which is displayed on a main screen globally exists in the content service, but still images such as photos, which are provided in the middle of broadcasting the program, and text such as captions, do not globally exist in (or occupy) an entire interval of the content service. In this case, for media data such as still images and text, multiplexing the media data items in a packetization layer and transmitting the plurality of media data items through one transmission channel is more effective than assigning an independent transmission channel for each media data item and transmitting the media data.

Whether media data is continuous is determined by whether or not media data should be continuously provided for a period for a content service. The period may be predetermined. Audio and video data can be regarded as continuous data, but media data such as still images and text, which are discontinuously provided in a content service, can be regarded as discontinuous data. In this case, if the data is determined to be discontinuous media data, multiplexing the media data items in a packetization layer and transmitting the plurality of media data items through one transmission channel is more effective than assigning an independent transmission channel for each media data item and transmitting the media data.

In relation to whether a media data item is related to at least one or more other media data items, text information or lyric additional information on audio data such as, for example, text information or lyric information, can be regarded as being related to audio data. If the information items related to each other are multiplexed and transmitted according to the current exemplary embodiment, the multiplexed information can be efficiently transmitted.

The packetization layer packetizing unit 530 packetizes encoded media data, thereby generating a packet of a packetization layer which is identified by a stream identifier. Media data for which multiplexing is determined to be performed in the media characteristic analysis unit 520 is assigned an identifier for identifying a stream, and is generated as a packet in which encoded media data, i.e., an access unit, is included in the payload field. If it is assumed that a stream identifier which is assigned for a first time is referred to as a first stream identifier and a packet which is packetized for the first time is referred to as a first packet, the first packet is input again to the packetization layer packetizing unit 530, as indicated by an arrow 10, such that the first packet is included in a payload to which a second stream identifier is assigned in relation to the identifier of the first packet, and thus can be multiplexed in a second packet. That is, the second packet has a recursive structure in which the first packet is included as an aggregated unit in the payload field. A method of generating a packet of a packetization layer having a recursive structure can be performed in various ways.

Since the second stream identifier is assigned for multiplexing of media data, the second stream identifier can also be assigned to a second media data item which has a same multiplexing structure as the first media data item and is transmitted through a same transmission channel as that of the first media data item. In this case, the second media data item is generated as a packet of a packetization layer to which a stream identifier for identifying the second media data item as the first media data item is assigned. Then, a packet is generated in which the packet of the packetization layer of the second media data item identified by the second stream identifier is included as an aggregated unit in the payload field. The multiplexing process can be performed a number of times in relation to a media data item according to a multiplexing structure determined in the media characteristic analysis unit 520. The media data item may be predetermined.

The second stream identifier can be used as an identifier of a packet including a third media data item in the payload field. As described above with reference to FIG. 3, even though the stream identifiers are identical, an access unit can be included in the payload field according to the payload data type, and a packet of another packetization layer can also be included in the payload field. That is, at least one packet that is identified by an identifier the same as the second stream identifier can exist, and the at least one packet having the identical identifier can include media data or decoding information in the payload field according to the payload data type.

The transport layer processing unit 540 processes the generated packet in the transport layer according to the transmission channel, and transmits the packet.

When an MPEG-2 TS is used as a transport layer, the transport layer processing unit 540 assigns a packet identification (PID) as a transmission channel. When a real-time protocol (RTP) is used as a transport layer, the transport layer processing unit 540 assigns a port number as a transmission channel.

FIG. 6 is a flowchart illustrating a method of transmitting media data according to an exemplary embodiment of the present invention.

In operation S610, it is determined based on a characteristic of media data whether to multiplex an input media data item. The characteristic of the input media data item denotes at least one of whether or not media data globally exists in a content service including at least one media data item, whether or not media data is continuous, and whether or not a media data item is related to one or more other media data items.

In operation S620, at least one stream identifier for identifying a packet of a packetization layer of a media data item for which multiplexing is determined to be performed is determined.

In operation S630, the media data item is packetized, thereby generating a packet of a packetization layer identified by the stream identifier. The packet for which multiplexing is determined to be performed has a recursive structure in which an aggregated packet is included in the packetization layer packet. In this way, the packet having the recursive structure is generated by firstly packetizing the media data item for which multiplexing is determined to be performed in operation S620, as a packet identified by a first stream identifier, and secondly packetizing the firstly packetized packet as a packet identified by a second stream identifier. This process may be performed a number of times, thereby generating a packet of a packetization layer having a recursive structure. In this case, one or more packets identified by identical identifiers can exist, and in such a case, one packet may be a packet for transmitting media data or decoding information and another packet may be a packet for transmitting an aggregated unit.

In operation S640, the generated packet is transmitted.

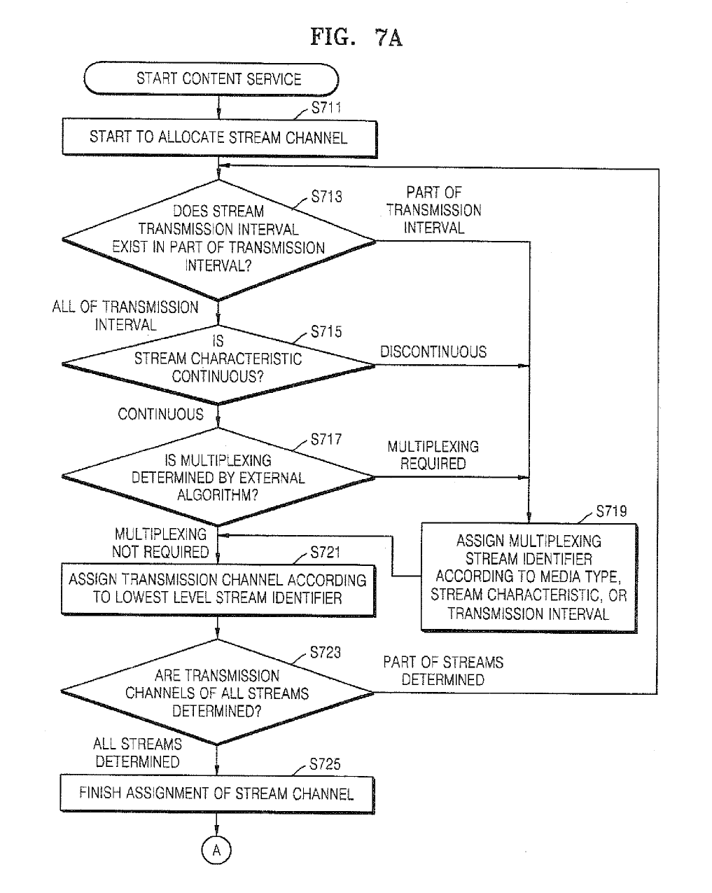

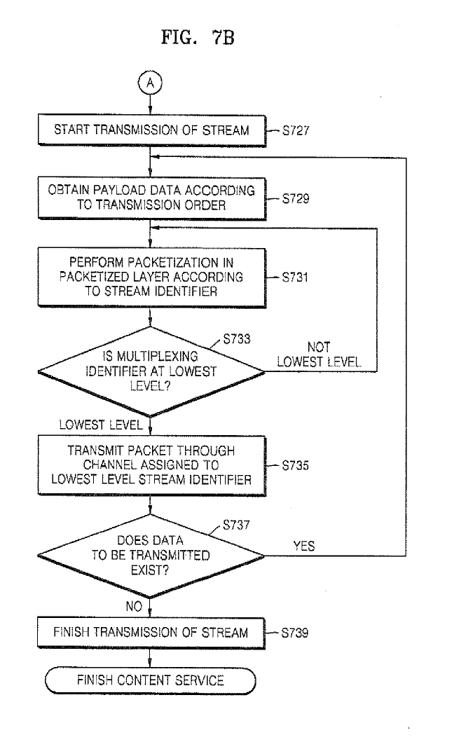

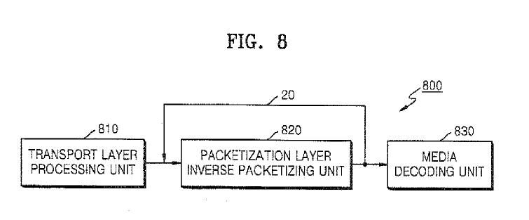

FIGS. 7A and 7B are a more detailed flowchart illustrating the method of transmitting media data illustrated in FIG. 6 according to an exemplary embodiment of the present invention.

The process illustrated in FIG. 7A may be performed in the media characteristic analysis unit 520. If a content service begins, allocation of a stream channel begins in operation S711. That is, a process of assigning a stream identifier to each media data item begins.

In operation S713, it is determined whether or not the stream transmission interval of a media data item globally exists in the content service by determining whether a stream transmission interval exists in part of a transmission interval or in all of a transmission interval. When it is determined that the media data item occupies an entire interval of the content service, it is determined in operation S715 whether or not the stream characteristic of the media data item is continuous. If it is determined that the characteristic of the stream is continuous, it is determined in operation S717 whether or not multiplexing is determined by an external algorithm. If it is determined that multiplexing is determined by an external algorithm, it is determined in operation S717 that multiplexing according to an exemplary embodiment of the present invention is not necessary.

The sequence of operations S713 through S717 may be changed. Also, another operation to determine whether or not it is necessary to multiplex input media data may be additionally performed. In other words, additional criteria may be evaluated for determining whether it is advantageous to use multiplexing according to an exemplary embodiment of the present invention. For example, if one or more media data items relate to each other, it may be determined that multiplexing according to an exemplary embodiment of the present invention may be advantageous.

If it is determined that media data exists in part of the content service in operation S713 and thus the media stream occupies only a part of the content service, or if it is determined in operation S715 that the characteristic of the media stream is discontinuous, or if it is determined in operation S717 that multiplexing is necessary, operation S719 is performed. In operation S719, a stream identifier is assigned according to the media type, the stream characteristic, or the transmission interval.

If, in operations S713, S715, and S717, it is determined that multiplexing is not necessary, a stream identifier which is assigned when multiplexing does not need to be performed, i.e., a stream identifier according to a related art technology, is assigned to a packet of a packetization layer to be transmitted through a transport layer. In this case, the stream identifier assigned to the packet of the packetization layer can be regarded as being assigned to a lowest level in terms of media data, and therefore it is referred to as a lowest level stream identifier. In operation S721, a transmission channel is assigned according to the lowest level stream identifier. In operation S723, it is determined whether transmission channels of all streams have been determined. If it is determined that a transmission channel is determined for every media data item forming the content service, the process of assigning a stream channel is finished in operation S725. If it is determined that only part of the streams are determined, then the process returns to operation S713.

The process illustrated in FIG. 7B may be performed mainly in the packetization layer packetizing unit 530.

In operation S727, the process of transmitting a stream begins. Payload data is obtained according to the transmission order of the media data in operation S729. The payload data can be obtained from the packetization layer packetizing unit 530 in the sequence of a media stream output from the media encoding unit 510. In operation S731, packetization of the packetization layer is performed based on the stream identifier assigned to each media item in operation S719. In operation S733, it is determined if a multiplexing identifier is at a lowest level. If it is determined that a lowest level stream identifier is not assigned to the media data item for which multiplexing is determined to be performed, operation S731 is performed again.

In operation S733, if it is determined that the multiplexing identifier is at a lowest level, the packet is transmitted through a transmission channel assigned to the lowest level stream identifier in operation S735. The transmission process may be performed in the transport layer processing unit 540. This process is repeatedly performed, and it is determined in operation S737 if data to be transmitted still exists. If it is determined in operation S737 that transmission of all data is performed, the transmission of the media stream is finished in operation S739 and the content service is stopped. If it is determined that data still exists to be transmitted, the process returns to operation S729.

FIG. 8 is a block diagram illustrating a structure of an apparatus for receiving media data according to an exemplary embodiment of the present invention. The media data reception apparatus 800 comprises a transport layer processing unit 810, a packetization layer inverse packetizing unit 820, and a media decoding unit 830.

The transport layer processing unit 810 processes transport layer data transmitted through a transmission channel, thereby generating a packetization layer packet. The transmission channel may be predetermined. The packetization layer inverse packetizing unit 820 inverse packetizes the received packetization layer packet, and confirms the payload data type of the packet.

If the payload data type indicates that an aggregated unit having a same packet structure as that of the packetization layer packet is included in the payload field of the packet, the packetization layer inverse packetizing unit 820 receives again the input of the aggregated unit included in the payload field, as indicated by an arrow 20, and inverse packetizes the aggregated unit using the same inverse packetization method. If the payload data type indicates that media data is included in the payload field of the packet, the packetization layer inverse packetizing unit 820 outputs the media data to the media decoding unit 830 and controls the data to be decoded. The media decoding unit 830 includes a decoder capable of decoding media data encoded by JPEG, MPEG, AAC, and the like, and decodes the media data.

When one or more packets having identical stream identifiers are received and one or more packets are selected from the received packets, the packetization layer inverse packetizing unit 820 selects remaining packets which have an identical stream identifier together to process the packets having the identical stream identifier. In many cases, media data items that are included in the packets having identical stream identifiers are related to each other. That is, packets having identical stream identifiers include media data items related to each other.

In this case, for example, when a user wants a content in a content service not to be provided, the user can prevent the remaining packets having stream identifiers that are identical to those of the content not to be provided, from being decoded so that the remaining packets can be filtered together. The content not to be provided may be predetermined. Accordingly, the packetization layer inverse packetizing unit 820 can control the decoding unit 830 so that selected packets having identical stream identifiers can be processed in an identical manner.

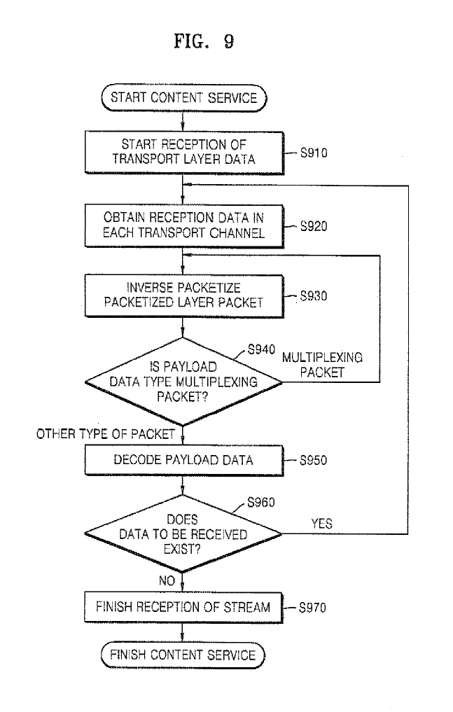

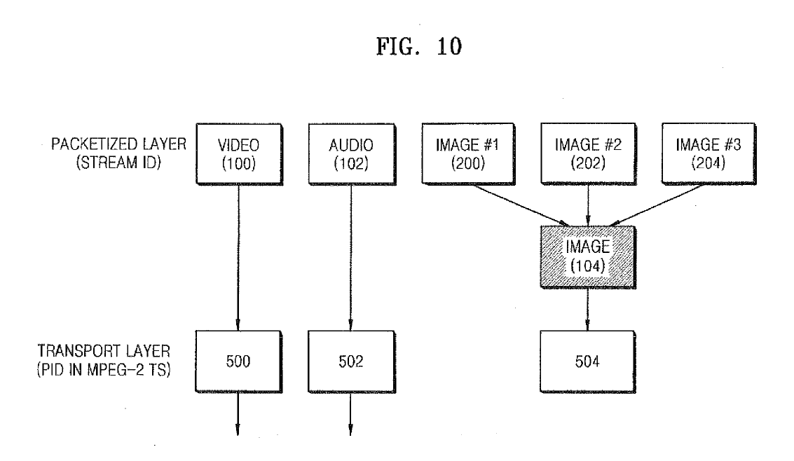

FIG. 9 is a flowchart illustrating a method of receiving media data according to an exemplary embodiment of the present invention.

If a content service is provided, data of a transport layer is received in operation S910. In operation S920, data received in each transport channel is obtained and a packet of a packetization layer is generated. In operation S930, the packet of each packetization layer received is inverse packetized. In operation S940, it is determined if the payload data type is a type containing multiplexed data. If it is determined that the payload data type indicates a multiplexed packet in which an aggregated unit is included, operation S930 is performed again. That is, if the packet is a multiplexed packet and the payload data type indicates that a packet having the same packet structure as that of the packetization layer packet is included in the payload, the included packet is inverse packetized in the same manner as the previously performed inverse packetization in operation S930.

If it is determined that the payload data type indicates that media data which is not an aggregated unit is included in the payload field, the media data included in the payload field is decoded in operation S950. If information other than the media data is included in the payload field, the other information can be processed.

In operation S960, it is determined whether or not data to be received exists. If it is determined that data to be received exists, the process returns to operation S920. If it is determined that no data to be received exists, operation S970 is performed, thereby finishing reception of a transport layer stream and finishing the content service.

Meanwhile, when one or more packets having identical stream identifiers are received and one or more packets are selected from the received packets, a process of selecting the remaining packets having the identical stream identifier together and performing identical processing for the selected packets having the identical stream identifiers can be further performed.

FIG. 10 is a diagram illustrating a structure of layers when a transport layer according to an exemplary embodiment of the present invention is an MPEG-2 transport stream (TS).

When the transport layer is an MPEG-2 TS, a packet of a packetization layer, such as an MPEG-4 SAF packet or an MPEG-2 TS packet, can have a packet structure including a stream identifier and a payload data type. In FIG. 10, it is assumed that a content service formed with 5 media streams is provided. The media data transmission apparatus 500 according to an exemplary embodiment of the present invention determines whether to multiplex each media data item according to a characteristic of media, as illustrated in FIG. 10, and a number of times multiplexing is to be performed, thereby determining an entire multiplexing structure.

In the packetization layer in FIG. 10, according to the determined multiplexing structure, a stream identifier 100 is assigned to a video stream, a stream identifier 102 is assigned to an audio stream, a stream identifier 200 is assigned to an image #1, a stream identifier 202 is assigned to an image #2, and a stream identifier 204 is assigned to an image #3.

The images #1 through #3 having stream identifiers 200, 202, and 204, respectively, are again packetized and multiplexed into a packet, as an aggregated unit, having a lower layer stream identifier 104. A packet identification (PID) of a transport layer is assigned to the packetization layer packet, thereby assigning a transmission channel and then transmitting the packet. For example, the video stream having a stream identifier 100 is assigned transport layer channel 500, the audio stream having a stream identifier 102 is assigned transport layer channel 502, and the images #1 through #3, which are aggregated a packet having a lower layer stream identifier 104 is assigned to transport layer channel 504.

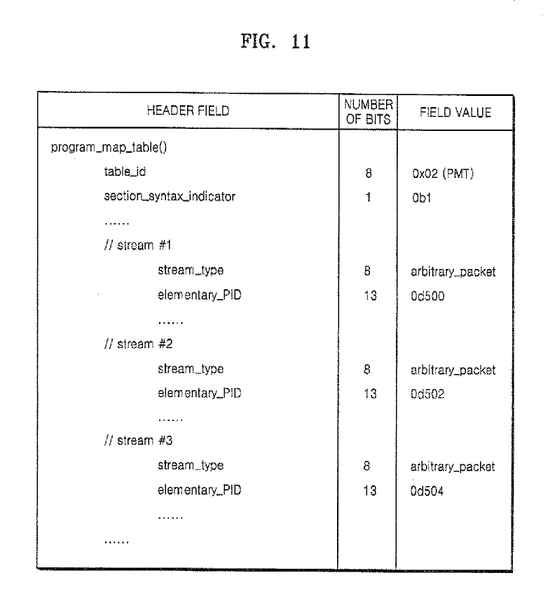

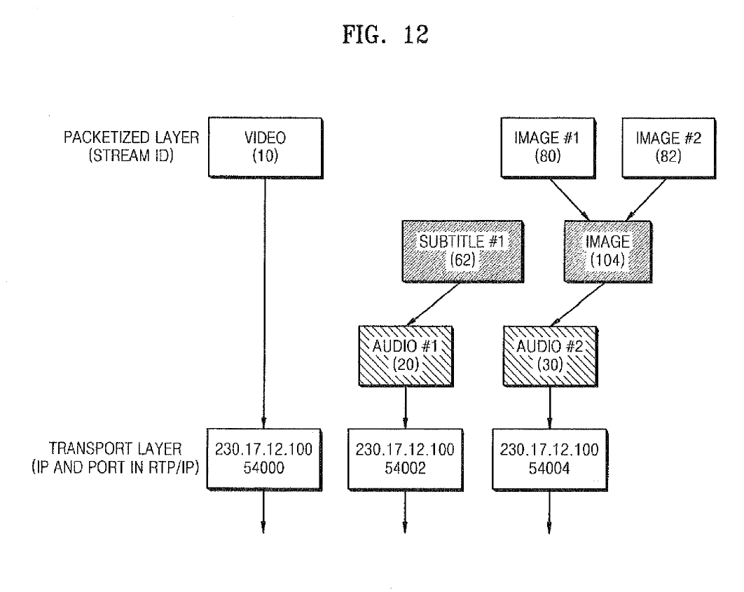

FIG. 11 is a diagram illustrating a structure of a program map table (PMT) of the MPEG-2 TS in the case illustrated in FIG. 10 according to an exemplary embodiment of the present invention.

FIG. 11 shows channel mapping information of FIG. 10. Referring to FIG. 11, in the MPEG-2 TS which is the transport layer, channel mapping information is transmitted according to the PMT. As illustrated in FIG. 11, referring to field values, the PMT structure indicates that the 5 media streams are multiplexed according to an exemplary embodiment of the present invention, and transmitted through 3 channels 500, 502, and 504.

FIG. 12 is a diagram illustrating a structure of layers when a transport layer according to an exemplary embodiment of the present invention is a real-time transport protocol (RTP).

If the transport layer is RTP, a packet of a packetization layer can have a packet structure including a stream identifier and a payload data type. In FIG. 12, it is assumed that a content service formed with 6 media streams is provided.

In the packetization layer in FIG. 12, a stream identifier 10 is assigned to a video stream, a stream identifier 20 is assigned to an audio #1, a stream identifier 30 is assigned to an audio #2, a stream identifier 60 is assigned to a subtitle #1, a stream identifier 80 is assigned to an image #1, and a stream identifier 82 is assigned to an image #2. The stream identifier 20 is assigned to a packet transporting the audio #1 in the payload field, and to a packet included in the payload, including an aggregated unit of the subtitle #1 whose stream identifier is 60. Also, the stream identifier 30 is assigned to a packet transporting the audio #2, and to a packet generated by performing multiplexing many times.

That is, a packet, which transports the image #1 to which the stream identifier 80 is assigned, is included in and multiplexed into the payload of a packet to which a stream identifier 104 is assigned. Then, the packet to which the stream identifier 104 is assigned is multiplexed into a packet to which the stream identifier 30 is assigned. Then, the packet is allocated to a transmission channel in which the IP address of the transport layer is 230.17.12.100 and the port number is 54004, and then, transmitted. Also, in the case of the image #2 to which the stream identifier 82 is assigned, the image #2 is multiplexed in the same manner as that of the image #1 and transmitted through an identical transmission channel. In this way, one or more packets identified by an identical stream identifier can exist, and according to the payload data type, a media data item or aggregated unit can be included in the payload field.

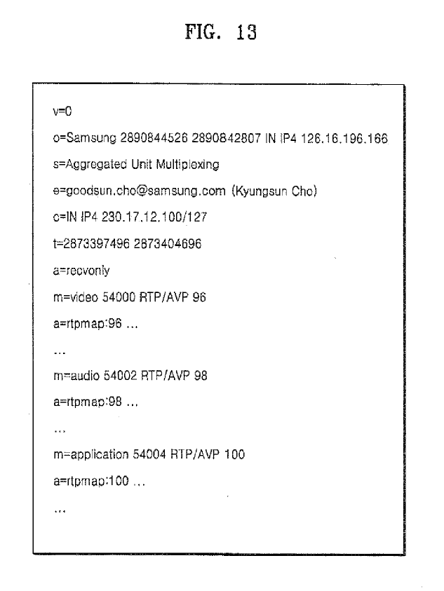

FIG. 13 is a diagram illustrating a structure of a session description protocol (SDP) of the RTP in the case illustrated in FIG. 13 according to an embodiment of the present invention.

FIG. 13 shows channel mapping information of FIG. 12. In FIG. 12, when the transport layer is the RTP, channel mapping information is transmitted according to the SDP. As illustrated in FIG. 13, the SDP structure indicates that six media streams are transmitted through three channels, 54000, 54002, and 54005, in which the IP address is 230.17.112.100 in the transport layer.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, or optical data storage devices. The computer readable recording medium can also be distributed over network coupled computer systems so that the computer readable code is stored and executed in a distributed fashion.

According to exemplary embodiments of the present invention as described above, even without a separate multiplexing or multiplexing apparatus, multiplexing of a packet of a packetization layer is performed according to a method of recursively packetizing a packet of a packetization layer again as a packet of another packetization layer. Accordingly, when media data is transmitted, according to exemplary embodiments of the present invention, multiplexing apparatuses or methods other than packetization of a packetization layer do not need to be used in the packetization layer, and generation of separate multiplexing information is not necessary. Therefore, the structure of a media data transmission apparatus and method can be simplified.

Also, according to exemplary embodiments of the present invention, when a multiplexed packet of a packetization layer is processed in a media data reception apparatus, the multiplexed packet can be demultiplexed even without a separate apparatus for demultiplexing a multiplexed packet. In this way, a process for processing the packet of the packetization layer can be simplified and a media stream can be effectively received and processed.

Furthermore, packets to which identical stream identifiers are assigned are made to be selected and processed together, which makes it easier to provide media data desired by a user. That is, contents related to each other can be easily provided and, conversely, contents related to content which the user does not want can be easily filtered and blocked as a whole.

While the present inventive concept has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of transmitting media data, the method comprising:
determining whether to multiplex a media data item, based on a characteristic of the media data item;
determining at least one stream identifier for identifying a packetization layer packet of a media data item for which multiplexing is determined to be performed;
packetizing the media data item for which multiplexing is determined to be performed to generate a packetization layer packet which is identified by the stream identifier; and
transmitting the packetization layer packet,
wherein the packetization layer packet has a recursive structure in which an aggregated unit having a same packet structure as the packetization layer packet is included in a payload field of the packetization layer packet.

2. The method of claim 1, wherein the characteristic of the media data item is at least one of whether the media data item globally exists in a content service including at least one media data item, whether the media data item is continuous, and whether the media data item is related to at least one other media data item.

3. The method of claim 1, wherein at least one other packet identified by a same stream identifier as the packetization layer packet exists, and the at least one other packet having the same stream identifier transmits media data or decoder information in the payload field according to a payload data type.

4. The method of claim 1, wherein the packetization layer packet having the recursive structure is generated by firstly packetizing the media data item for which multiplexing is determined to be performed, as a packet identified by a first stream identifier, and secondly packetizing the packet identified by the first stream identifier, as a packet identified by a second stream identifier.

5. The method of claim 1, wherein the generating of the packetization layer packet is performed at least once.

6. An apparatus for transmitting media data, the apparatus comprising:
a media characteristic analysis unit which determines whether to multiplex a media data item, based on a characteristic of the media data item, and determines at least one stream identifier for identifying a packetization layer packet of the media data item for which multiplexing is determined to be performed;
a packetization layer packetizing unit which packetizes the media data item to generate a packetization layer packet which is identified by the stream identifier; and
a transport layer processing unit which transmits the packetization layer packet,
wherein the packetization layer packet has a recursive structure in which an aggregated unit having a same packet structure as the packetization layer packet is included in a payload field of the packetization layer packet.

7. The apparatus of claim 6, wherein the characteristic of the media data item is at least one of whether the media data item globally exists in a content service including at least one media data item, whether the media data item is continuous, and whether the media data item is related to at least one other media data item.

8. The apparatus of claim 6, wherein at least one other packet identified by a same stream identifier as the stream identifier of the packetization layer packet exists, and the at least one other packet having the same stream identifier transmits media data or decoder information in the payload field of the packetization layer packet according to a payload data type.

9. The apparatus of claim 6, wherein the packetization layer packet having the recursive structure is generated by firstly packetizing the media data item for which multiplexing is determined to be performed, as a packet identified by a first stream identifier, and secondly packetizing the packet identified by the first stream identifier, as a packet identified by a second stream identifier.

10. The apparatus of claim 6, wherein the packetization layer packetizing unit performs at least once a process of generating the packet in relation to the media data item for which multiplexing is determined to be performed, thereby generating the packetization layer packet having the recursive structure.

11. A method of receiving media data, the method comprising:
processing received transport layer data to generate a packetization layer packet;
inverse packetizing the packetization layer packet and identifying a payload data type of the packetization layer packet; and
if the payload data type indicates that an aggregated unit having a same packet structure as a packet structure of the packetization layer packet is included in a payload field of the packetization layer packet, inverse packetizing the aggregated unit in a same manner as the inverse packetizing of the packetization layer packet.

12. The method of claim 11, further comprising, if the payload data type indicates that a media data item is included in the payload field of the packet, decoding the media data item.

13. The method of claim 11, wherein when at least two packetization layer packets having identical stream identifiers are received and at least one packetization layer packet is selected from among the packetization layer packets having identical stream identifiers, the remaining packetization layer packets having the identical stream identifiers are selected together.

14. The method of claim 13, wherein identical processing is performed for the selected packetization layer packets having the identical stream identifiers.

15. The method of claim 13, wherein the packetization layer packets having the identical stream identifiers have media data items related to each other.

16. An apparatus for receiving media data, the apparatus comprising:
a transport layer processing unit which processes received transport layer data to generate a packetization layer packet; and
a packetization layer inverse packetizing unit which inverse packetizes the received packetization layer packet, and identifies a payload data type of the packetization layer packet,
wherein if the payload data type indicates that an aggregated unit having a same packet structure as a packet structure of the packetization layer packet is included in a payload field of the packetization layer packet, the packetization layer inverse packetizing unit inverse packetizes the aggregated unit in a same manner as the inverse packetizing of the packetization layer packet.

17. The apparatus of claim 16, further comprising a decoding unit which decodes a media data item if the payload data type indicates that a media data item is included in the payload field of the packetization layer packet, the decoding unit decodes the media data item.

18. The apparatus of claim 16, wherein when at least two packetization layer packets having identical stream identifiers are received and at least one packetization layer packet is selected from among the packetization layer packets having identical stream identifiers, the packetization layer inverse packetizing unit controls such that the remaining packetization layer packets having the identical stream identifiers are selected together.

19. The apparatus of claim 18, wherein the packetization layer inverse packetizing unit controls the decoding unit such that identical processing is performed for the selected packetization layer packets having the identical stream identifiers.

20. The apparatus of claim 18, wherein the packetization layer packets having the identical stream identifiers have media data items related to each other.

21. A computer readable recording medium having embodied thereon a computer program for executing a method of transmitting media data, wherein the method comprises:
determining whether to multiplex a media data item, based on a characteristic of the media data item;
determining at least one stream identifier for identifying a packetization layer packet of the media data item for which multiplexing is determined to be performed;
packetizing the media data item to generate the packetization layer packet which is identified by the stream identifier; and
transmitting the packetization layer packet,
wherein the packetization layer packet has a recursive structure in which an aggregated unit having a same packet structure as a packet structure of the packetization layer packet is included in a payload field of the packetization layer packet.

22. A computer readable recording medium having embodied thereon a computer program for executing a method of receiving media data, wherein the method comprises:
processing received transport layer data to generate a packetization layer packet;
inverse packetizing the packetization layer packet, and identifying a payload data type of the packetization layer packet; and
if the payload data type indicates that an aggregated unit having a same packet structure as that of the packetization layer packet is included in a payload field of the packetization layer packet, inverse packetizing the aggregated unit in a same manner as the inverse packetizing of the packetization layer packet.
